(19) United States
(12) Patent Application Publication
(10) Pub. No.: US 2026/0100920 A1
(43) Pub. Date: Apr. 9, 2026

(54) MULTI-PORT NETWORK INTERFACE CARD (NIC)

(71) Applicant: Owl Cyber Defense Solutions, LLC, Columbia, MD (US)

(72) Inventors: Brian John KANE, Columbia, MD (US); Timothy Mark FAHL, II, Columbia, MD (US); Steven STAUBLY, Columbia, MD (US)

(73) Assignee: Owl Cyber Defense Solutions, LLC, Columbia, MD (US)

(21) Appl. No.: 18/966,653

(22) Filed: Dec. 3, 2024

Related U.S. Application Data
(60) Provisional application No. 63/704,317, filed on Oct. 7, 2024.

(51) Int. Cl. H04L 49/25; H04L 49/102

(52) U.S. Cl. CPC H04L 49/256; H04L 49/102

(57) ABSTRACT

Systems, methods, and apparatuses disclosed herein can enable a computing system to connect to a network. These systems, methods, and apparatuses can connect the computing system to the network through multiple network connections. These multiple network connections represent distinct, physically separate signal pathways to improve security. This physical separation, or isolation, from one another creates distinct boundaries between these multiple network connections, for example, to minimize shared resources these systems, methods, and apparatuses. These distinct boundaries can reduce the vulnerability of these systems, methods, and apparatuses to, for example, attacks that exploit shared sources among these systems, methods, and apparatuses, data leakage within these systems, methods, and apparatuses, and/or unauthorized access to these systems, methods, and apparatuses. Moreover, these distinct boundaries can additionally enhance security by improving fault isolation, enforcing access control, and/or supporting secure communication protocols, among others, within these systems, methods, and apparatuses.

### CROSS-REFERENCE TO RELATED APPLICATIONS

The present application claims the benefit of U.S. Provisional Patent Application No. 63/704,317, filed Oct. 7, 2024, which is incorporated herein by reference in its entirety.

### BACKGROUND

Network interface cards (NICs) have undergone significant evolution alongside advancements in networking technology, becoming essential for high-speed and efficient network communication. In high-performance and data-center environments, modern NICs now support speeds well beyond traditional gigabit Ethernet, with 10 Gbps, 25 Gbps, and even 100 Gbps connections for enterprise applications. This transition is largely driven by the escalating demand for faster data transmission, fueled by the proliferation of cloud computing, artificial intelligence, machine learning, and big data processing. These technologies require robust network infrastructures that can handle vast amounts of data quickly and reliably.

### BRIEF DESCRIPTION OF THE DRAWINGS

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates a simplified block diagram of an exemplary computing system according to some exemplary embodiments of the present disclosure;

FIG. 2 illustrates a simplified block diagram of an exemplary network interface card (NIC) that can be implemented within the exemplary computing system according to some exemplary embodiments of the present disclosure;

FIG. 3 illustrates a simplified block diagram of a first exemplary network interface card (NIC) communication lane that can be implemented within the exemplary NIC according to some exemplary embodiments of the present disclosure;

FIG. 4 illustrates a simplified block diagram of a second exemplary network interface card (NIC) communication lane that can be implemented within the exemplary NIC according to some exemplary embodiments of the present disclosure; and

FIG. 5 illustrates an exemplary operational control flow for communicating data packets using the exemplary network interface card (NIC) according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within 1-15% of the value (e.g., ±1%, ±2%, ±5%, ±10%, or ±15% of the value).

### Overview

Systems, methods, and apparatuses disclosed herein can enable a computing system to connect to a network. These systems, methods, and apparatuses can connect the computing system to the network through multiple network connections. These multiple network connections represent distinct, physically separate signal pathways to improve security. This physical separation, or isolation, from one another creates distinct boundaries between these multiple network connections, for example, to minimize shared resources these systems, methods, and apparatuses. These distinct boundaries can reduce the vulnerability of these systems, methods, and apparatuses to, for example, attacks that exploit shared sources among these systems, methods, and apparatuses, data leakage within these systems, methods, and apparatuses, and/or unauthorized access to these systems, methods, and apparatuses. Moreover, these distinct boundaries can additionally enhance security by improving fault isolation, enforcing access control, and/or supporting secure communication protocols, among others, within these systems, methods, and apparatuses.

### Exemplary Computing System

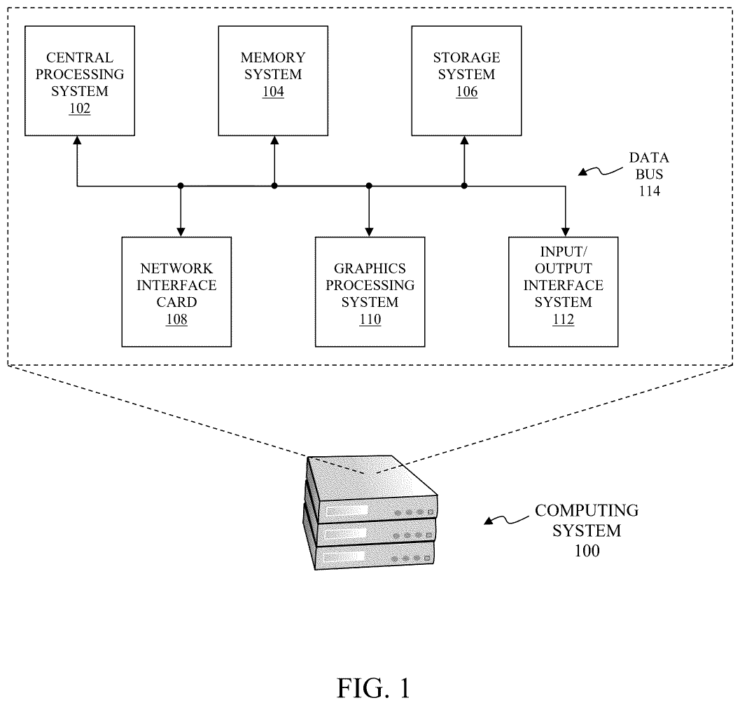

FIG. 1 illustrates a simplified block diagram of an exemplary computing system according to some exemplary embodiments of the present disclosure. In the exemplary embodiment illustrated in FIG. 1, a computing system 100 represents a combination of hardware and/or software that functionally cooperate with one another to process data, execute instructions, and/or perform computational tasks, among others. In some embodiments, the computing system can input, store, process, and/or output electronic data to solve problems, perform calculations, and/or manage tasks efficiently, among others. In some embodiments, the computing system 100 can vary in size and complexity ranging from simple devices, such as desktop workstations, to more complicated devices, such as supercomputers. The computing system 100 can receive data and/or instructions, execute instructions, and/or perform calculations, save data for future use, and/or deliver the results of the instructions, among others. As illustrated in FIG. 1, the computing system 100 can include a central processing system 102, a memory system 104, a storage system 106, a network interface card (NIC) 108, a graphics processing system 110, and/or an input/output interface system 112 that are communicatively coupled to one another via a data bus 114. However, those skilled in the relevant art(s) will recognize that the computing system 100 can include one or more other suitable systems, such as a power supply system, often referred to as a power supply unit (PSU) and/or a cooling system, among others, that will be apparent to those skilled in the relevant art(s) without departing from the spirit and scope of the present disclosure.

Although not illustrated in FIG. 1, the computing system 100 can include one or more specialized centralized electronic circuit boards, often referred to as motherboards, to communicatively couple the central processing system 102, the memory system 104, the storage system 106, the NIC 108, the graphics processing system 110, and/or the input/output interface system 112 to one another. These motherboards provide electronic structures and/or signals pathways for the central processing system 102, the memory system 104, the storage system 106, the NIC 108, the graphics processing system 110, and/or the input/output interface system 112 to functionally cooperate with one another. In some embodiments, the one or more motherboards can include one or more sockets, slots, ports, connectors, or the like to communicatively couple the central processing system 102, the memory system 104, the storage system 106, the NIC 108, the graphics processing system 110, and/or the input/output interface system 112 to one another. In these embodiments, the central processing system 102, the memory system 104, the storage system 106, the NIC 108, the graphics processing system 110, and/or the input/output interface system 112 can be connected to, for example, plugged-into, these sockets, slots, ports, connectors, or the like. In these embodiments, these sockets, slots, ports, connectors, or the like can be compliant with various industry standards and/or specifications, such as the Industry Standard Architecture (ISA), Peripheral Component Interconnect (PCI), PCI Express (PCIe), Accelerated Graphics Port (AGP), Universal Serial Bus, (USB), Small Computer System Interface (SCSI), Dual Inline Memory Module (DIMM), M.2 Slots, Serial Advanced Technology Attachment (SATA) connectors, Extended Industry Standard Architecture (EISA), Low Pofile Extension (LPX) and/or Advanced Technology Extended (ATX), among others. Alternatively, or in addition to, the central processing system 102, the memory system 104, the storage system 106, the NIC 108, the graphics processing system 110, and/or the input/output interface system 112 can be integrated onto the one or more motherboards.

The central processing system 102 represents a primary, or main, processor of the computing system 100 to process, calculate, and/or control instructions from a computer program, such as arithmetic, logic, controlling, and input/output (I/O) instructions to provide some examples. Although not illustrated in FIG. 1, the central processing system 102 can include one or more central processing units (CPUs) to execute instructions, perform calculations, and mange flow of data throughout the computing system 100. In some embodiments, the one or more CPUs can include one or more control units (CUs) to manage and/or to coordinate the execution of the instructions, one or more arithmetic logic unit (ALUs) to execute arithmetic and/or logic operations on binary integer numbers from instructions provided by the one or more CUs, a register to store data, often temporary, for processing, a cache memory to store frequently accessed data and instructions, an instruction decoder to interpret instructions for the one or more ALUs, and/or one or more floating point units (FPUs) to execute arithmetic and logic operations on floating point numbers from the instructions provided by the one or more CUs to provide some examples.

The memory system 104 represents a short-term storage area, often referred to as volatile memory, to temporarily store instructions and/or data that are needed by the computing system 100 to execute instructions. The memory system 104 can be characterized as providing the computing system 100 with high-speed access to frequently used data and/or instructions. In some embodiments, the memory system 104 can include, but is not limited to, random-access memory (RAM) Dynamic RAM, Static RAM, and/or Double Data Rate (DDR) RAM; cache memory, such as L1 Cache memory, L2 Cache memory, and/or L3 Cache memory, to provide some examples, and/or read only memory (ROM), among others.

The storage system 106 represents a long-term storage area, often referred to as non-volatile memory, to permanently, or semi-permanently, store programs, files, and/or data. In some embodiments, these programs, files, and/or data can include, or be related to, the operating system, software applications, documents and files, media content, archived data, installers, system files and configurations, and/or software updates, among others. In some embodiments, the storage system 106 can include hard disk drives, solid-state drives (SSDs), hybrid drives (SSHD), optical drives, floppy disk drives along with associated removable media, CD-ROM drives, optical drives, flash memories, and/or removable media cartridges.

The NIC 108 can enable the computing system 100 to connect to a network. In some embodiments, the NIC 108 can serve as an interface between the computing system 100 and the network allowing for communication between the computing system 100 and the network. In these embodiments, the NIC 108 forms a bridge between the computing system 100 and the network communication data transmission and/or reception between the computing system 100 and the network. In these embodiments, the NIC 108 can handle data transmission over various types of networks, utilizing different wireless and/or wired technologies, such as Ethernet, Wi-Fi, and/or fiber optics, among others. In some embodiments, the NIC 108 can represent a multi-port NIC, for example, four (4) port, that can enable the computing system 100 to connect to the network through multiple network connections. In these embodiments, the NIC 108 can include multiple NIC communication lanes to connect to the network through the multiple network connections. In some embodiments, the multiple NIC communication lanes represent distinct, physically separate signal pathways within the NIC 108 to prevent unauthorized access to or interference among these NIC communication lanes. In these embodiments, the multiple NIC communication lanes can be physically separated, or isolated, from one another to improve security within the NIC 108 by, for example, preventing interference or cross-talk between these NIC communication lanes. In some embodiments, the NIC 108 can be implemented as one or more expansion cards that can be connected to, for example, plugged-into, the one or more sockets, slots, ports, connectors, or the like on the one or more motherboards. In these embodiments, these sockets, slots, ports, connectors, or the like can provide the necessary electrical connections and pathways for data transmission between the NIC 108 and the central processing system 102, the memory system 104, the storage system 106, the graphics processing system 110, and/or the input/output interface system 112. Alternatively, or in addition to, the NIC 108 can be integrated directly onto the one or more motherboards to provide an onboard NIC, also referred to as an integrated NIC.

The graphics processing system 110 represents a secondary, or auxiliary, processor, of the computing system 100 that can accelerate rendering and/or manipulation of images, videos, and other graphic-related tasks. Although not illustrated in FIG. 1, the central processing system 102 can include one or more graphical processing units (GPUs) to execute graphic intensive operations, such as matrix calculations, texture mapping, lighting effects, and/or rendering polygons, among others to provide some examples. Although not illustrated in FIG. 1, the one or more GPUs can include multiple processing cores that execute instructions in parallel, a memory that stores information for the multiple processing cores, texture units to sample and to filter textures for images, videos, and other graphic-related tasks, rasterizers to convert three-dimensional images, videos, and other graphic-related tasks to two-dimensional images, videos, and other graphic-related tasks, a texture cache to store frequently access texture data, and/or geometry shaders to process geometry data for images, videos, and other graphic-related tasks to provide some examples.

The input/output interface system 112 facilitates communication between the computing system 100 and external devices or systems, such as peripheral devices keyboards, mice, scanners, webcams, microphones, monitors, printers, and/or speakers, among others. In some embodiments, the input/output interface system 112 include one or more input/output ports to transfer data between the computing system 100 and these peripheral devices. In these embodiments, the one or more input/output ports can be compliant with various industry standards and/or specifications, such as Universal Serial Bus (USB), Ethernet, High-Definition Multimedia Interface (HDMI), DisplayPort, Video Graphics Array (VGA), Digital Visual Interface (DVI), Thunderbolt, External Serial Advanced Technology Attachment (eSATA), and/or Firewire, among others.

The data bus 114 enables communication among the central processing system 102, the memory system 104, the storage system 106, the NIC 108, the graphics processing system 110, and/or the input/output interface system 112. In some embodiments, the data bus 114 can be characterized as including multiple lanes that allow for the simultaneous transmission of data. In these embodiments, the multiple lanes can include data buses, address buses for specifying the address to read data from or write data into, and/or control buses that manage the operation of the computing system 100. In some embodiments, the architecture and functionality of the data bus 114 can be compliant with various industry standards and/or specifications, such as the Industry Standard Architecture (ISA), Peripheral Component Interconnect (PCI), PCI Express (PCIe), Accelerated Graphics Port (AGP), Universal Serial Bus, (USB), and/or Small Computer System Interface (SCSI), among others.

### Exemplary Network Interface Card (NIC) That Can Be Implemented Within The Exemplary Computing System

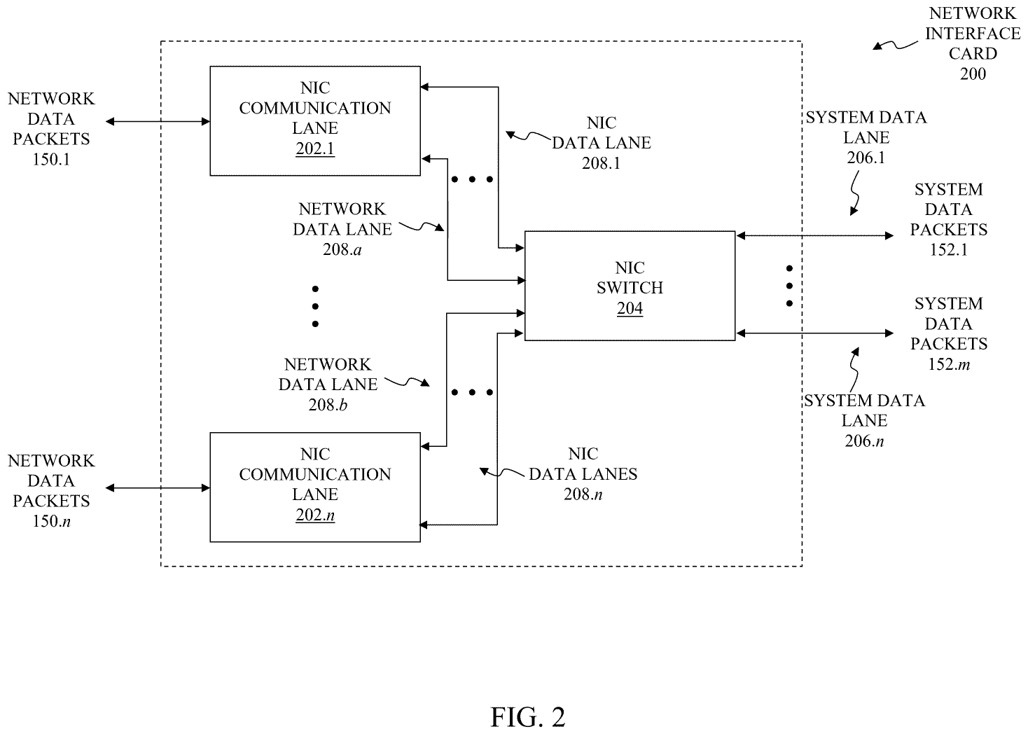

FIG. 2 illustrates a simplified block diagram of an exemplary network interface card (NIC) that can be implemented within the exemplary computing system according to some exemplary embodiments of the present disclosure. In the exemplary embodiment illustrated in FIG. 2, a network interface card (NIC) 200 can enable a host computing system, such as the computing system 100 to provide an example, to connect to a network. In some embodiments, the NIC 200 can represent a multi-port, for example, four (4) port, NIC that can connect the host computing system to the network through multiple NIC communication lanes. In some embodiments, the multiple NIC communication lanes can communicate, for example, transmit and/or receive, network data packets 150.1 through 150.n between the NIC 200 and the network. And the NIC 200 can communicate system data packets 152.1 through 152.m between the NIC 200 and the host computing system. As illustrated in FIG. 2, the NIC 200 can include NIC communication lanes 202.1 through 202.n and a NIC switch 204. The NIC 200 can represent an exemplary embodiment of the NIC 108 described herein.

The NIC communication lanes 202.1 through 202.n can provide, for example, packet transmission and reception, error detection, and/or protocol management, among others, to ensure efficient data flow between the computing system 100 and the network. In some embodiments, the NIC communication lanes 202.1 through 202.n represent multiple pathways, channels, or the like to communicate network data packets 150.1 through 150.n between the NIC 200 and the network. In these embodiments, the NIC communication lanes 202.1 through 202.n can include full-duplex NIC communication lanes that enable simultaneous sending and receiving of the network data packets 150.1 through 150.n, half duplex NIC communication lanes that enable sending or receiving of the network data packets 150.1 through 150.n, or any combination thereof. In some embodiments, the NIC communication lanes 202.1 through 202.n can communicate the network data packets 150.1 through 150.n over various types of networks utilizing different wired technologies, such as Ethernet, optical, and/or power line communication (PLC), among others, and/or wireless technologies, such as Wi-Fi, Bluetooth, cellular, and/or satellite, among others.

As illustrated in FIG. 2, the NIC communication lanes 202.1 through 202.n can receive the network data packets 150.1 through 150.n. In some embodiments, the NIC communication lanes 202.1 through 202.n can receive the network data packets 150.1 through 150.n from the network over wireless and/or wired communication channels, such as Ethernet communication channels, optical communication channels, power line communication (PLC) communication channels, Wi-Fi communication channels, Bluetooth communication channels, cellular communication channels, and/or satellite communication channels, among others. In some embodiments, these NIC communication lanes can recover the system data packets 152.1 through 152.m from the network data packets 150.1 through 150.n and can thereafter provide the system data packets 152.1 through 152.m over the NIC data lanes 208.1 through 208.n to the NIC switch 204. Alternatively, or in addition to, the NIC communication lanes 202.1 through 202.n can transmit the network data packets 150.1 through 150.n. In some embodiments, the NIC communication lanes 202.1 through 202.n can transmit the network data packets 150.1 through 150.n to the network over wireless and/or wired communication channels, such as Ethernet communication channels, optical communication channels, power line communication (PLC) communication channels, Wi-Fi communication channels, Bluetooth communication channels, cellular communication channels, and/or satellite communication channels, among others. In some embodiments, these NIC communication lanes can receive the system data packets 152.1 through 152.m over the NIC data lanes 208.1 through 208.n from the NIC switch 204 and can thereafter generate the network data packets 150.1 through 150.n from the system data packets 152.1 through 152.m. In some embodiments, the NIC communication lanes 202.1 through 202.n can perform one or more operations, routines, procedures, or the like on the network data packets 150.1 through 150.n and/or the system data packets 152.1 through 152.m, such as transmission and reception, signal conversion, modulation and demodulation, segmentation, reassembly, protocol management, traffic control, lane activation, lane deactivation, bandwidth allocation, lane redundancy and failover, lane speed control, multiplexing and demultiplexing, power management, error detection and correction, traffic prioritization, and/or hot-swapping, among others.

In the exemplary embodiment illustrated in FIG. 2, the NIC communication lanes 202.1 through 202.n represent distinct, physically separate signal pathways within the NIC 200 to advantageously improve security within the NIC 200. In some embodiments, the NIC communication lanes 202.1 through 202.n can be physically separated, or isolated, from one another to improve security within the NIC 200 by, for example, preventing unauthorized access to or interference between these NIC communication lanes. This physical separation, or isolation, from one another creates distinct boundaries between the NIC communication lanes 202.1 through 202.n to, for example, to minimize shared resources among the NIC communication lanes 202.1 through 202.n. In these embodiments, these distinct boundaries can reduce the vulnerability of the NIC 200 to, for example, attacks that exploit shared sources among the NIC 200, data leakage within the NIC 200, and/or unauthorized access to the NIC 200. Moreover, these distinct boundaries can additionally enhance security by improving fault isolation, enforcing access control, and/or supporting secure communication protocols, among others, within the NIC 200.

The NIC switch 204 facilitates the integration of the NIC communication lanes 202.1 through 202.n onto the NIC 200 while maintaining stability and performance. In some embodiments, the NIC switch 204 manages the flow of data between the computer system and the NIC communication lanes 202.1 through 202.n. As illustrated in FIG. 2, the NIC switch 204 can receive the network data packets 150.1 through 150.n over the NIC data lanes 208.1 through 208.n from the NIC switch 204 and can thereafter provide the network data packets 150.1 through 150.n as the system data packets 152.1 through 152.m to the host computer system over the system data lanes 206.1 through 206.n. Collectively, the system data lanes 206.1 through 206.n can be implemented within one or more sockets, slots, ports, connectors, or the like of the host computer system that can be used to connect, for example, plug, the NIC 200 to the host computer system. Alternatively, or in addition to, the NIC switch 204 can receive the system data packets 152.1 through 152.m from the host computer system over the system data lanes 206.1 through 206.n and can thereafter provide the system data packets 152.1 through 152.m to the NIC communication lanes 202.1 through 202.n over the NIC data lanes 208.1 through 208.n. In some embodiments, the NIC switch 204 can receive each system data packet from among the system data packets 152.1 through 152.m over multiple system data lanes from among the system data lanes 206.1 through 206.n. Alternatively, or in addition to, the NIC switch 204 can provide each network data packet from among the network data packets 150.1 through 150.n to the host computer system over multiple system data lanes from among the system data lanes 206.1 through 206.n. In these embodiments, these multiple system data lanes can include a pair of data lanes to enable differential signaling. Generally, the system data lanes 206.1 through 206.n and/or NIC data lanes 208.1 through 208.n represent pathways, channels, or the like for full-duplex, for example, transmitting and receiving, communication of data. In some embodiments, these data lanes can include pathways, channels, or the like for transmitting data and other pathways, channels, or the like for receiving data. In these embodiments, the pathways, channels, or the like for transmitting data and/or the other pathways, channels, or the like for receiving data can include pairs of pathways, channels, or the like for differential signaling. In some embodiments, the system data lanes 206.1 through 206.n and/or the NIC data lanes 208.1 through 208.n can be complaint with one or more interface standards, such as Peripheral Component Interconnect (PCI), PCI Express (PCIe), Universal Serial Bus (USB), Serial ATA (SATA), Thunderbolt, High-Definition Multimedia Interface (HDMI), DisplayPort, Ethernet, and/or Firewire, among others.

In the exemplary embodiment illustrated in FIG. 2, the NIC switch 204 can assign, allocate, or map the system data lanes 206.1 through 206.n to corresponding NIC data lanes from among the NIC data lanes 208.1 through 208.n that are associated with a corresponding NIC communication lane from among the NIC communication lanes 202.1 through 202.n. In some embodiments, the NIC switch 204 can split, or bifurcate, the system data lanes 206.1 through 206.n into the corresponding NIC data lanes. In these embodiments, the NIC switch 204 can split, or bifurcate, the system data lanes 206.1 through 206.n into n-groups of corresponding NIC data lanes from among the NIC data lanes 208.1 through 208.n corresponding to the network data packets 150.1 through 150.n. As illustrated in FIG. 2, the n-groups of NIC data lanes can include a first group of system data lanes 208.1 through 208.a from among the NIC data lanes 208.1 through 208.n that is associated with the network data packet 150.1 and/or the system data packet 152.1 through an n^{th} group of system data lanes 208.b through 208.n from among the NIC data lanes 208.1 through 208.n that is associated with the network data packet 150.n and/or the system data packet 152.n. As an example, the sixteen (16) system data lanes 206.1 through 206.16 of a Peripheral Component Interconnect Express (PCIe) socket, slot, port, connector, or the like can be bifurcated into four (4) groups of four (4) system data lanes to enable the four (4) network connections over the NIC 200. In some embodiments, the NIC switch 204 can access one or more registers to assign, allocate, or map the system data lanes 206.1 through 206.n to the corresponding NIC data lanes from among the NIC data lanes 208.1 through 208.n that are associated with corresponding NIC communication lanes from among the NIC communication lanes 202.1 through 202.n. In these embodiments, the one or more registers can include one or more control registers, status registers, configuration registers, interrupt registers, and/or error handling registers, among others. In some embodiments, the computer system and/or the NIC communication lanes 202.1 through 202.n can read and/or write to the one or more registers, for example, configuration registers, to assign, allocate, or map the system data lanes 206.1 through 206.n to the corresponding NIC data lanes. In these embodiments, the computer system and/or the NIC communication lanes 202.1 through 202.n can read and/or write to one or more routing tables that are stored in the one or more registers, or otherwise accessible by the NIC switch 204.

In some embodiments, the assigning, allocating, or mapping of the system data lanes 206.1 through 206.n can be dynamically configured on-the-fly in response to, for example, operational needs or conditions of the NIC 200. In these embodiments, the NIC switch 204 can dynamically adjust the number of lanes assigned to the n-groups of NIC data lanes from among the NIC data lanes 208.1 through 208.n in response to, for example, operational needs or conditions demands of the NIC 200. For example, the NIC switch 204 can dynamically allocate more system data lanes from among the system data lanes 206.1 through 206.n to one of the n-groups of NIC data lanes from among the NIC data lanes 208.1 through 208.n that requires more bandwidth while allocating less system data lanes from among the system data lanes 206.1 through 206.n to another one of the n-groups of NIC data lanes from among the NIC data lanes 208.1 through 208.n that requires less bandwidth to optimize performance and resource utilization.

After assigning, allocating, or mapping the system data lanes 206.1 through 206.n to the NIC data lanes 208.1 through 208.n, the NIC switch 204 can route the system data packets 152.1 through 152.m that are received over the system data lanes 206.1 through 206.n onto their corresponding NIC data lanes from among the NIC data lanes 208.1 through 208.n to route the system data packets 152.1 through 152.m to their corresponding NIC communications lane from among the NIC communication lanes 202.1 through 202.n. Alternatively, or in addition to, the NIC switch 204 can route the network data packets 150.1 through 150.n that are received over the NIC data lanes 208.1 through 208.n onto their corresponding system data lanes from among the system data lanes 206.1 through 206.n. In some embodiments, the NIC communication lanes 202.1 through 202.n represent n-uniquely addressable electronic devices, for example, n-uniquely addressable Peripheral Component Interconnect Express (PCIe) devices. In these embodiments, the NIC switch 204 can implement a hierarchical addressing scheme that utilizes, for example, bus, device, function (BDF) addressing and/or various packet structures, such as, address fields, to route data to the NIC communication lanes 202.1 through 202.n. In some embodiments, the NIC switch 204 can receive the system data packets 152.1 through 152.m that include address fields that identify corresponding NIC communication lanes from among the NIC communication lanes 202.1 through 202.n. In these embodiments, the NIC switch 204 can read the address fields of the system data packets 152.1 through 152.m to route the system data packets 152.1 through 152.m to the corresponding NIC communication lanes from among the NIC communication lanes 202.1 through 202.n.

### Exemplary Network Interface Card (NIC) Communication Lanes That Can Be Implemented Within The Exemplary NIC

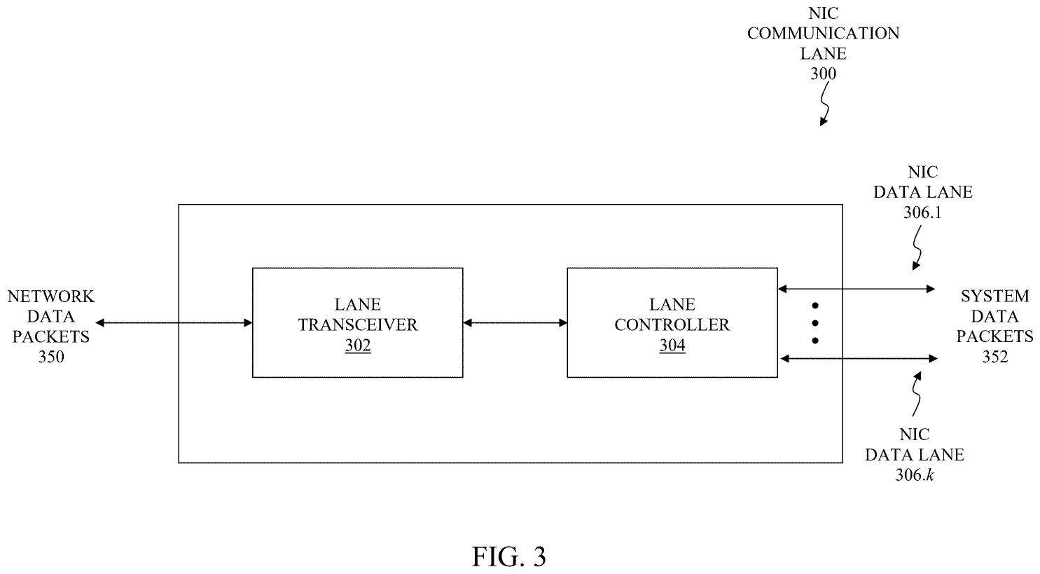

FIG. 3 illustrates a simplified block diagram of a first exemplary network interface card (NIC) communication lane that can be implemented within the exemplary NIC according to some exemplary embodiments of the present disclosure. In the exemplary embodiment illustrated in FIG. 3, a network interface card (NIC) communication lane 300 can communicate, for example, transmit and/or receive, network data packets 350 between a NIC, such as the NIC 108 and/or the NIC 200 to provide some examples, and a network. As illustrated in FIG. 3, the NIC communication lane 300 can receive system data packets 352 over NIC data lanes 306.1 through 306.k. In some embodiments, the NIC data lanes 306.1 through 306.k can include two pairs of two NIC data lanes to enable simultaneous full-duplex differential signaling. In some embodiments, the NIC communication lane 300 can thereafter generate the network data packets 350 from the system data packets 352. And as illustrated in FIG. 3, the NIC communication lane 300 can receive the network data packets 350 from the network. In some embodiments, the NIC communication lane 300 can recover the system data packets 352 from the network data packets 350 and can thereafter provide the system data packets 352 over the NIC data lanes 306.1 through 306.k to the NIC. As illustrated in FIG. 3, the NIC communication lane 300 can include a lane transceiver 302 and a lane controller 304.

The lane transceiver 302 can communicate network data packets 350 between the NIC 200 and the network. In these embodiments, the lane transceiver 302 can include full-duplex NIC communication lanes that enable simultaneous sending and receiving of the network data packets 350, half duplex NIC communication lanes that enable sending or receiving of the network data packets 350, or any combination thereof. In some embodiments, the lane transceiver 302 can communicate the network data packets 350 over various types of networks utilizing different wired technologies, such as Ethernet, optical, and/or power line communication (PLC), among others, and/or wireless technologies, such as Wi-Fi, Bluetooth, cellular, and/or satellite, among others.

The lane transceiver 302 can receive the network data packets 350. In some embodiments, the lane transceiver 302 can receive the network data packets 350 from the network over wireless and/or wired communication channels, such as Ethernet communication channels, optical communication channels, power line communication (PLC) communication channels, Wi-Fi communication channels, Bluetooth communication channels, cellular communication channels, and/or satellite communication channels, among others. In some embodiments, the lane transceiver 302 can include an Ethernet transceiver, an optical transceiver, a power line communication (PLC) transceiver, a Wi-Fi transceiver, a Bluetooth transceiver, a cellular transceiver, and/or a satellite transceiver, among others. In some embodiments, the lane transceiver 302 can recover the system data packets 352 from the network data packets 350 and can thereafter provide the system data packets 352 to the lane controller 304. Alternatively, or in addition to, the lane transceiver 302 can transmit the network data packets 350. In some embodiments, the lane transceiver 302 can receive the system data packets 352 from the lane controller 304 and can thereafter generate the network data packets 350 from the system data packets 352. In some embodiments, the lane transceiver 302 can perform one or more operations, routines, procedures, or the like on the network data packets 350 and/or the system data packets 352, such as transmission and reception, signal conversion, and/or modulation and demodulation among others.

The lane controller 304 can manage network communications for the NIC communication lane 300. In these embodiments, these controllers, processors, chips, cores, engines, or the like can handle tasks for the NIC communication lane 300, such as packet transmission and reception, error detection, and/or protocol management, among others, to ensure efficient data flow between the NIC and the network. As illustrated in FIG. 3, the lane controller 304 can receive the system data packets 352 over the NIC data lanes 306.1 through 306.k and can thereafter provide the system data packets 352 to the lane transceiver 302. And as illustrated in FIG. 3, the lane controller 304 can receive the system data packets 352 from the lane transceiver 302 and can thereafter provide the system data packets 352 over the NIC data lanes 306.1 through 306.k to NIC. In some embodiments, the lane controller 304 can perform one or more operations, routines, procedures, or the like on the system data packets 352, such as segmentation, reassembly, protocol management, traffic control, lane activation, lane deactivation, bandwidth allocation, lane redundancy and failover, lane speed control, multiplexing and demultiplexing, power management, error detection and correction, traffic prioritization, and/or hot-swapping, among others.

In the exemplary embodiment illustrated in FIG. 3, the NIC communication lane 300 represents a distinct, physically separate signal pathway from other NIC communication lanes within the NIC as described herein. In some embodiments, the lane transceiver 302 and the lane controller 304 can be physically separated, or isolated, from other transceivers and/or controllers of other NIC communication lanes within the NIC to prevent unauthorized access to or interference between these NIC communication lanes. As such, the lane transceiver 302 and the lane controller 304 can be characterized as being a dedicated transceiver and a dedicated controller, respectively, for the NIC communication lane 300. In some embodiments the dedicated transceiver and/or the dedicated controller can process the system data packets 352 with lower latency compared to shared or general-purpose transceivers and/or controllers. This can be beneficial for application that require real-time data transfer, such as gaming, video streaming, and/or data center operations, among others. In some embodiments, the dedicated transceiver and/or the dedicated controller can advantageously provide optimized signal pathways, channels, or the like for communicating the network data packets 350 and less contention with other NIC communication lanes within the NIC resulting in faster and more reliable communication. In some embodiments, the dedicated transceiver and/or the dedicated controller can advantageously lessen the risk of bottlenecks within the NIC and/or improve fault tolerance. For example, a fault elsewhere in another NIC communication lane is less likely to affect the NIC communication lane 300. In some embodiments, the dedicated transceiver and/or the dedicated controller can be configured to meet specific operational needs or conditions, for example, bandwidth, power consumption, and/or special communication protocols, among others. In some embodiment, the dedicated transceiver and/or the dedicated controller can isolate the NIC communication lane 300 from the other NIC communication lanes within the NIC to enhance security, for example, by increase the difficulty for malicious software to interfere with operation of the NIC communication lane 300 or to gain unauthorized access to data.

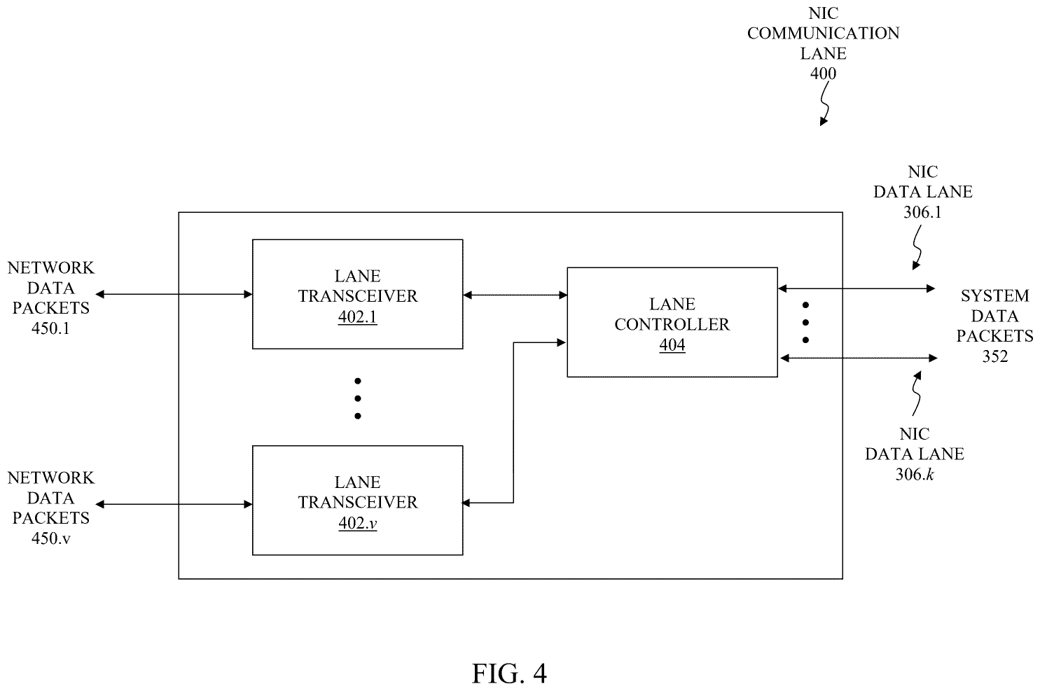

FIG. 4 illustrates a simplified block diagram of a second exemplary network interface card (NIC) communication lane that can be implemented within the exemplary NIC according to some exemplary embodiments of the present disclosure. In the exemplary embodiment illustrated in FIG. 4, a network interface card (NIC) communication lane 400 can communicate, for example, transmit and/or receive, network data packets 450.1 through 450.v between a NIC, such as the NIC 108 and/or the NIC 200 to provide some examples, and a network. In some embodiments, the network data packets 450.1 through 450.v can collectively represent a data packet and/or one or more fragments of the data packet. As illustrated in FIG. 4, the NIC communication lane 400 can receive system data packets 352 over the NIC data lanes 306.1 through 306.k. And as illustrated in FIG. 4, the NIC communication lane 400 can receive the network data packets 450.1 through 450.v from the network. In some embodiments, the NIC communication lane 400 can recover the system data packets 352 from network data packets 450.1 through 450.v and can thereafter provide the system data packets 352 over the NIC data lanes 306.1 through 306.k to the NIC. As illustrated in FIG. 4, the NIC communication lane 400 can include lane transceivers 402.1 through 402.v and a lane controller 404. The NIC communication lane 400 shares many substantially similar features as the NIC communication lane 300; therefore, only differences between the NIC communication lane 400 and the NIC communication lane 300 are to be described in further detail below.

The lane transceivers 402.1 through 402.v share many substantially similar features as the lane transceiver 302; therefore, only differences between the lane transceivers 402.1 through 402.v and the lane transceiver 302 are to be described in further detail below. As illustrated in FIG. 4, the lane transceivers 402.1 through 402.v can receive the network data packets 450.1 through 450.v. In some embodiments, the lane transceivers 402.1 through 402.v can simultaneously send and/or receive multiple network data packets from among the network data packets 450.1 through 450.v to beneficially increase, for example, throughput and reliability. In some embodiments, the lane transceivers 402.1 through 402. can receive the network data packets 450.1 through 450.v from the network over wireless and/or wired communication channels, such as Ethernet communication channels, optical communication channels, power line communication (PLC) communication channels, Wi-Fi communication channels, Bluetooth communication channels, cellular communication channels, and/or satellite communication channels, among others. In some embodiments, the lane transceivers 402.1 through 402.v can include one or more Ethernet transceivers, one or more optical transceivers, one or more power line communication (PLC) transceivers, one or more Wi-Fi transceivers, one or more Bluetooth transceivers, one or more cellular transceivers, and/or one or more satellite transceiver, among others. In some embodiments, the lane transceivers 402.1 through 402.v can recover the system data packets 352 from the network data packets 450.1 through 450.v and can thereafter provide the system data packets 352 to the lane controller 404. Alternatively, or in addition to, the lane transceivers 402.1 through 402.v can transmit the network data packets 450.1 through 450.v. In some embodiments, the lane transceivers 402.1 through 402.v can receive the system data packets 352 from the lane controller 304 and can thereafter generate the network data packets 450.1 through 450.v from the system data packets 352. In some embodiments, the lane transceivers 402.1 through 402.v can perform one or more operations, routines, procedures, or the like on the network data packets 450.1 through 450.v and/or the system data packets 352, such as transmission and reception, signal conversion, and/or modulation and demodulation among others. In some embodiments, the lane transceivers 402.1 through 402.v can provide system redundancy for the NIC communication lane 400. In these embodiments, the system redundancy allows the NIC communication lane 400 to re-route the system data packets 352 in response to a failure of one or more lane transceivers from among the lane transceivers 402.1 through 402.v. In some embodiments, the lane transceivers 402.1 through 402.v can transmit the network data packets 450.1 through 450.v in parallel to increase the overall data rate of the NIC communication lane 400, to provide redundancy to assist with signal fading or interference, and/or to increase the signal strength, and hence, the range of the NIC communication lane 400.

The lane controller 404 shares many substantially similar features as the lane controller 304; therefore, only differences between the lane controller 404 and the lane controller 304 are to be described in further detail below. The lane controller 404 can further manage the distribution of the system data packets 352 among the lane transceivers 402.1 through 402.v to, for example, optimize performance, ensure redundancy, and/or maintain load balancing across the NIC. In some embodiments, the lane controller 404 can perform operations, routines, procedures, or the like ranging from a simple round-robin approach to distribute the system data packets 352 evenly across the lane transceivers 402.1 through 402.v and/or more complicated load-balancing algorithms to distribute the system data packets 352 even across the lane transceivers 402.1 through 402.v. In some embodiments, the lane controller 404 can assign the system data packets 352 across the lane transceivers 402.1 through 402.v based upon operational needs or conditions of the NIC 200, for example, Quality of Service (QoS), latency, and/or bandwidth requirements.

### Exemplary Operational Control Flow For The Exemplary Network Interface Card (NIC)

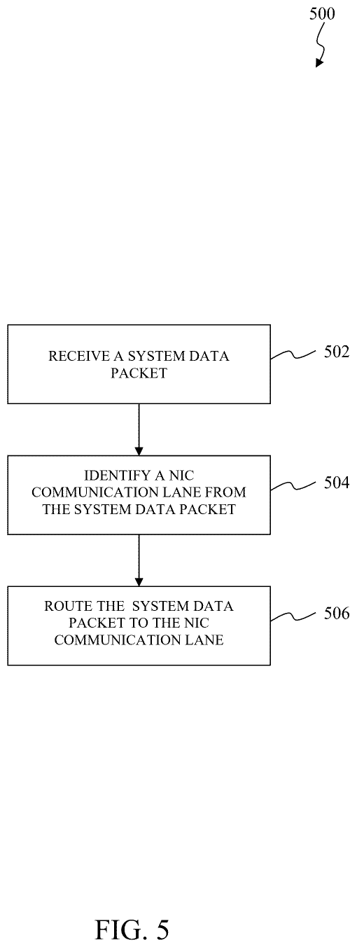

FIG. 5 illustrates an exemplary operational control flow for communicating data packets using the exemplary network interface card (NIC) according to some exemplary embodiments of the present disclosure. The following discussion is to describe an exemplary operational control flow 500 for communicating data packets between a computing system, such as the computing system 100 to provide an example, and a network. The present disclosure is not limited to these exemplary operational control flows. Rather, it will be apparent to ordinary persons skilled in the relevant art(s) that other operational control flows are within the scope and spirit of the present disclosure. In some embodiments, the operational control flow 500 can be performed by a network interface card (NIC), such as the such as the NIC 108 and/or the NIC 200 to provide some examples. Generally, the network interface card (NIC) include n-uniquely addressable NIC communication lanes, such as the communication lanes 202.1 through 202.n to provide an example, to communicate the data packets between the computing system and the network.

At operation 502, the operational control flow 500 receives a data packet from the computing system. In some embodiments, the operational control flow 500 can receive the data packet from the computing system over one or more system data lanes, for example, one or more of the system data lanes 206.1 through 206.n. In some embodiments, the one or more system data lanes can be compliant with a Peripheral Component Interconnect Express (PCIe) interface standard. In these embodiments, the one or more system data lanes can be implemented within one or more sockets, slots, ports, connectors, or the like that are compliant with the Peripheral Component Interconnect Express (PCIe) interface standard. In some embodiments, these sockets, slots, ports, connectors, or the like can include sixteen (16) system data lanes that are complaint with the PCIe interface standard. In these embodiments, the operational control flow 500 can bifurcate the sixteen (16) system data lanes into four (4) groups of four (4) system data lanes. In these embodiments, each group of four (4) system data lanes includes a first pair of data lanes to enable differential transmission of data packets and a second pair of data lanes to enable differential receiving of data packets.

At operation 504, the operational control flow 500 identifies a NIC communication lane from among the n-uniquely addressable NIC communication lanes from the data packet from operation 502. In some embodiments, the data packet from operation 502 can include an address field that identifies the NIC communication lane to route the data packet from operation 502. In these embodiments, the operational control flow 500 can read the address field of the data packet from operation to identify the NIC communication lane.

At operation 506, the operation control flow 500 routes the data packet from operation 502 to the NIC communication lane from operation 504 for transmission to the network. In some embodiments, the operation control flow 500 can identify one or more NIC data lanes, for example, one or more of the NIC data lanes 208.1 through 208.n, that are associated with the NIC communication lane from operation 504. In some embodiments, the one or more NIC data lanes can be compliant with a Peripheral Component Interconnect Express (PCIe) interface standard. In these embodiments, the one or more NIC data lanes can include a first pair of data lanes to enable differential transmission of data packets and a second pair of data lanes to enable differential receiving of data packets. In some embodiments, the operational control flow 500 can access one or more registers that are utilized to assign, allocate, or map the system data lanes from operation 502 to the one or more NIC data lanes. In these embodiments, the operation control flow 500 can read one or more routing tables that are stored in the one or more registers, or that are otherwise accessible by the operational control flow 500, to identify that one or more NIC data lanes that are assigned, allocated, or mapped to the NIC communication lane from operation 504. After identifying the one or more NIC data lanes, the operation control flow 500 can routes the data packet from operation 502 to the NIC communication lane from operation 504 over the one or more NIC data lanes for transmission to the network.

### Conclusion

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A network interface card (NIC) for connecting a computer system to a network, the NIC comprising:
a plurality of NIC communication lanes, each NIC communication lane from among the plurality of NIC communication lanes including a corresponding lane controller from among a plurality of lane controllers and a corresponding lane transceiver from among a plurality of lane transceivers; and
a NIC switch configured to:
receive a data packet from the computer system over one or more system data lanes from among a plurality of system data lanes,
identify a corresponding NIC communication lane from among the NIC communication lanes to route the data packet and one or more NIC data lanes from among a plurality of NIC data lanes, each NIC data lane from among the plurality of NIC data lanes being associated with one of the corresponding NIC communication lanes, and
route the data packet over the one or more NIC data lanes to the corresponding NIC communication lane for transmission to the network.

2. The NIC of claim 1, wherein each NIC communication lane from among the plurality of NIC communication lanes is physically isolated from one another.

3. The NIC of claim 2, wherein each lane controller from among the plurality of lane controllers is physically isolated from one another, and
wherein each lane transceiver from among the plurality of lane transceivers is physically isolated from one another.

4. The NIC of claim 1, wherein the plurality of system data lanes and the plurality of NIC data lanes are complaint with a Peripheral Component Interconnect Express (PCIe) interface standard.

5. The NIC of claim 4, wherein the plurality of system data lanes comprises sixteen system data lanes, the sixteen system data lanes being bifurcated into four groups of four system data lanes,
wherein the NIC switch is configured to receive the data packet from the computer system over a corresponding group of four system data lanes from among the four groups of four system data lanes,
wherein the plurality of NIC data lanes comprises sixteen NIC data lanes, the sixteen NIC data lanes being bifurcated into four groups of four NIC data lanes,
wherein the NIC switch is configured to identify a corresponding group of four NIC lanes from among the plurality of NIC data lanes that are associated with the corresponding NIC communication lane, and
wherein the NIC switch is configured to route the data packet over the corresponding group of four NIC lanes to the corresponding NIC communication lane for transmission to the network.

6. The NIC of claim 1, wherein the NIC switch is further configured to bifurcate the plurality of system data lanes into a plurality of groups of system data lanes, and
wherein the NIC switch is configured to receive the data packet from the computer system over a corresponding group of system data lanes from among the plurality of groups of system data lanes,
wherein the NIC switch is configured to identify a corresponding group of NIC lanes from among plurality of NIC data lanes that are associated with the corresponding NIC communication lane, and
wherein the NIC switch is configured to route the data packet over the corresponding group of NIC lanes to the corresponding NIC communication lane for transmission to the network.

7. The NIC of claim 1, wherein the NIC is implemented onto an expansion card that is configured to be plugged into the computer system.

8. A computer system for connecting to a network, the computer system comprising:
a motherboard including a central processing system, a memory system, and a network interface card (NIC) connected to a slot on the motherboard, the NIC comprising:
a plurality of NIC communication lanes, each NIC communication lane from among the plurality of NIC communication lanes including a corresponding lane controller from among a plurality of lane controllers and a corresponding lane transceiver from among a plurality of lane controllers; and
a NIC switch configured to:
receive a data packet from the computer system over one or more system data lanes from among a plurality of system data lanes,
identify a corresponding NIC communication lane from among the NIC communication lanes to route the data packet and one or more NIC data lanes from among a plurality of NIC data lanes, each NIC data lane from among the plurality of NIC data lanes being associated with one of the corresponding NIC communication lanes,
route the data packet over the one or more NIC data lanes to the corresponding NIC communication lane for transmission to the network.

9. The computer system of claim 8, wherein each NIC communication lane from among the plurality of NIC communication lanes is physically isolated from one another.

10. The computer system of claim 9, wherein each lane controller from among the plurality of lane controllers is physically isolated from one another, and
wherein each lane transceiver from among the plurality of lane transceivers is physically isolated from one another.

11. The computer system of claim 8, wherein the plurality of system data lanes and the plurality of NIC data lanes are complaint with a Peripheral Component Interconnect Express (PCIe) interface standard.

12. The computer system of claim 11, wherein the plurality of system data lanes comprises sixteen system data lanes, the sixteen system data lanes being bifurcated into four groups of four system data lanes,
wherein the NIC switch is configured to receive the data packet from the computer system over a corresponding group of four system data lanes from among the four groups of four system data lanes,
wherein the plurality of NIC data lanes comprises sixteen NIC data lanes, the sixteen NIC data lanes being bifurcated into four groups of four NIC data lanes,
wherein the NIC switch is configured to identify a corresponding group of four NIC lanes from among the plurality of NIC data lanes that are associated with the corresponding NIC communication lane, and
wherein the NIC switch is configured to route the data packet over the corresponding group of four NIC lanes to the corresponding NIC communication lane for transmission to the network.

13. The computer system of claim 8, wherein the NIC switch is further configured to bifurcate the plurality of system data lanes into a plurality of groups of system data lanes, and
wherein the NIC switch is configured to receive the data packet from the computer system over a corresponding group of system data lanes from among the plurality of groups of system data lanes,
wherein the NIC switch is configured to identify a corresponding group of NIC lanes from among plurality of NIC data lanes that are associated with the corresponding NIC communication lane, and
wherein the NIC switch is configured to route the data packet over the corresponding group of NIC lanes to the corresponding NIC communication lane for transmission to the network.

14. A method for connecting a computer system to a network, the method comprising:
receiving, by a network interface card (NIC), a data packet from the computer system over one or more system data lanes from among a plurality of system data lanes;
identifying, by the NIC, a corresponding NIC communication lane from among a NIC communication lanes to route the data packet and one or more NIC data lanes from among a plurality of NIC data lanes that are associated with the corresponding NIC communication lane, each NIC communication lane from among the plurality of NIC communication lanes including a corresponding lane controller from among a plurality of lane controllers and a corresponding lane transceiver from among a plurality of lane controllers; and
routing, by the NIC, the data packet over the one or more NIC data lanes to the corresponding NIC communication lane for transmission to the network.

15. The method of claim 14, further comprising physically isolating each NIC communication lane from among the plurality of NIC communication lanes from one another.

16. The method of claim 15, further comprising:
physically isolating each lane controller from among the plurality of lane controllers from one another; and
physically isolating each lane transceiver from among the plurality of lane transceivers from one another.

17. The method of claim 14, wherein the plurality of system data lanes and the plurality of NIC data lanes are complaint with a Peripheral Component Interconnect Express (PCIe) interface standard.

18. The method of claim 17, wherein the plurality of system data lanes comprises sixteen system data lanes, the sixteen system data lanes being bifurcated into four groups of four system data lanes,
wherein the receiving comprises receiving the data packet from the computer system over a corresponding group of four system data lanes from among the four groups of four system data lanes,
wherein the plurality of NIC data lanes comprises sixteen NIC data lanes, the sixteen NIC data lanes being bifurcated into four groups of four NIC data lanes,
wherein the identifying comprises identifying a corresponding group of four NIC lanes from among the plurality of NIC data lanes that are associated with the corresponding NIC communication lane, and
wherein the routing comprises routing the data packet over the corresponding group of four NIC lanes to the corresponding NIC communication lane for transmission to the network.

19. The method of claim 14, wherein the NIC switch is further configured to bifurcate the plurality of system data lanes into a plurality of groups of system data lanes, and
wherein the receiving comprises receiving the data packet from the computer system over a corresponding group of system data lanes from among the plurality of groups of system data lanes,
wherein the identifying comprises identifying a corresponding group of NIC lanes from among plurality of NIC data lanes that are associated with the corresponding NIC communication lane, and
wherein the routing comprises the data packet over the corresponding group of NIC lanes to the corresponding NIC communication lane for transmission to the network.

20. The method of claim 14, further comprising plugging the into the computer system.
